(19) United States
(12) Patent Application Publication
(10) Pub. No.: US 2020/0090430 A1
(43) Pub. Date: Mar. 19, 2020

(54) Diagnostic System for a Transit Vehicle

(71) Applicant: Westinghouse Air Brake Technologies Corporation, Wilmerding, PA (US)

(72) Inventors: Karl J. Kobel, Wildwood, IL (US); Afsar Ali, Skokie, IL (US)

(21) Appl. No.: 16/228,989

(22) Filed: Dec. 21, 2018

Related U.S. Application Data
(60) Provisional application No. 62/732,326, filed on Sep. 17, 2018.

(51) Int. Cl. G07C 5/12; G07C 5/08; G06F 1/3231

(52) U.S. Cl. CPC G07C 5/12; G06F 1/3231; G07C 5/0825; G07C 5/0808

(57) ABSTRACT

A diagnostic system for a transit vehicle includes a display configured to display diagnostic information, and a control module including at least one processor programmed or configured to: receive a display signal from a display actuation sub-system and display the diagnostic information on the display. The diagnostic information includes one or more of a system status, operational counts and operating times, current faults and warnings, historical faults and warnings, a troubleshooting guide, and component documentation.

### CROSS-REFERENCE TO RELATED APPLICATION

This application claims priority to U.S. Provisional Application Ser. No. 62/732,326, filed Sep. 17, 2018, which is hereby incorporated by reference in its entirety.

### BACKGROUND OF THE INVENTION

### Field of the Invention

The present invention is directed to a diagnostic system for a transit vehicle.

### Description of Related Art

Transit vehicles, such as buses or passenger railway cars, include one or more doors that are opened and closed to allow the egress and ingress of passengers. Passengers stand near the doors to board the vehicle and also prior to exiting the vehicle. The door assemblies include multiple sub-systems that control various operations of the door while ensuring the safety of the passengers on the transit vehicle.

There are a number of different types of displays used to convey various information or to provide entertainment. The following patents disclose various types of displays and are hereby incorporated by reference in their entirety: EP 3066657A1, Transflective TFT Display; DE202016106621U1, TFT Common Backlight; EP 3291214A3 Dual Use Display; EP 3015915, Transparent Display; and DE202016106906U1, LED Between Glass.

### SUMMARY OF THE INVENTION

In one aspect, a diagnostic system for a transit vehicle includes a display configured to display diagnostic information, and a control module comprising at least one processor programmed or configured to: receive a display signal from a display actuation sub-system and display the diagnostic information on the display. The diagnostic information includes one or more of a system status, operational counts and operating times, current faults and warnings, historical faults and warnings, a troubleshooting guide, and component documentation.

The diagnostic information may include a system status, operational counts and operating times, current faults and warnings, and historical faults and warnings. The diagnostic information may further include a troubleshooting guide and component documentation.

The display actuation sub-system may include a sensor configured to detect a person on the transit vehicle. The sensor may be a passive infrared (PIR) sensor, a microwave sensor, an ultrasonic sensor, a vibration sensor, a pressure/contact sensor, and/or a camera-based sensor.

The display actuation sub-system may be a camera-based facial expression recognition system or gesture recognition system.

The display actuation sub-system may be a location-based sensor configured to send the display signal to the control module based on a location of the transit vehicle. The location-based sensor may be configured to send the display signal to the control module based on a location of the transit vehicle relative to a geo-fence.

The display actuation sub-system may include a first communication module on the transit vehicle and a second communication module at a repair facility, with the second communication module communicating with the first communication module to send the display signal to the control module.

The display actuation sub-system may be an input panel configured to be actuated by a user to send the display signal to the control module.

The display actuation sub-system may be a smart phone configured to send the display signal to the control module based on a user input on the smart phone or a location of the smart phone relative to the display.

The system status of the diagnostic information may be a normal indicator, a warning indicator, and a fault indicator. The system status of the diagnostic information may further include a sub-system status for each sub-system, with the sub-system status including a normal indicator, a warning indicator, and a fault indicator. The normal indicator for the sub-system status is a first color, the warning indicator for the sub-system status is a second color, and the fault indicator for the sub-system status is a third color, where the first color, the second color, and the third color are each a different color relative to each other.

In a further aspect, a computer-implemented method for displaying diagnostic information on a display for a transit vehicle includes: determining with at least one processor whether a display signal was received from a display actuation sub-system; and displaying the diagnostic information on a display, where the diagnostic information comprises one or more of a system status, operational counts and operating times, current faults and warnings, historical faults and warnings, a troubleshooting guide, and component documentation.

The display actuation sub-system may be a sensor, with the method further including detecting a presence of a person on the transit vehicle and generating the display signal.

The display actuation sub-system may be a location-based sensor, with the method further including detecting a location of the transit vehicle and generating the display signal based on the location of the transit vehicle. The method may further include detecting the location of the transit vehicle relative to a geo-fence.

The display actuation sub-system may include a first communication module on the transit vehicle and a second communication module at a repair facility, with the method further including enabling communication between the second communication module and the second communication module to send the display signal. The display actuation sub-system may be a smart phone, with the method further including detecting a location of the smart phone and generating the display signal based on the location of the smart phone.

### BRIEF DESCRIPTION OF THE DRAWINGS

FIG. 1 is a diagnostic system for a transit vehicle according to one aspect of the present invention.

FIG. 2 is a diagnostic system for a transit vehicle according to a second aspect of the present invention.

FIG. 3 is a diagnostic system for a transit vehicle according to a third aspect of the present invention.

FIG. 4 is a diagnostic system for a transit vehicle according to a fourth aspect of the present invention.

FIG. 5 is a schematic view of a display for a diagnostic system for a transit vehicle according to one aspect of the present invention.

FIG. 6 is a schematic view illustrating how the diagnostic system described herein may be utilized.

FIG. 7 is a schematic view of a vehicle door display system according to one aspect of the present invention.

### DETAILED DESCRIPTION

For purposes of the description hereinafter, spatial orientation terms, as used, shall relate to the referenced embodiment as it is oriented in the accompanying drawing figures or otherwise described in the following detailed description. However, it is to be understood that the embodiments described hereinafter may assume many alternative variations and configurations. It is also to be understood that the specific components, devices, and features illustrated in the accompanying drawing figures and described herein are simply exemplary and should not be considered as limiting.

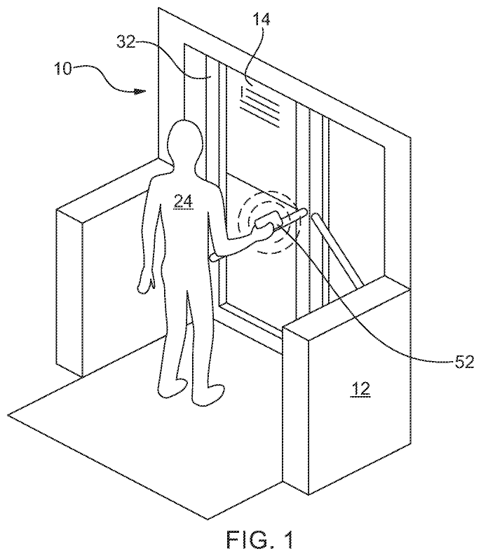

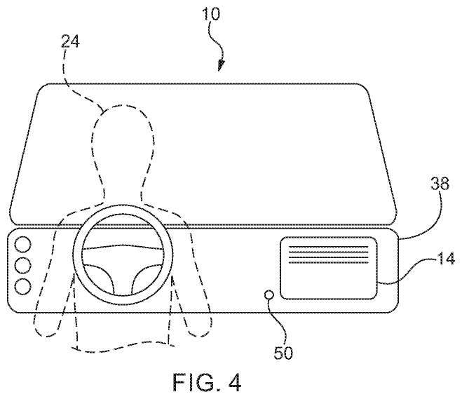

Referring to FIGS. 1-7, a diagnostic system 10 for a transit vehicle 12 includes a display 14 configured to display diagnostic information, and a control module 16 including at least one processor programmed or configured to: receive a display signal from a display actuation sub-system 18, and display the diagnostic information on the display. The diagnostic information includes one or more of a system status 20, operational counts and operating times 22, current faults and warnings 24, historical faults and warnings 26, a troubleshooting guide 28, and component documentation 30, although the diagnostic information may include other suitable diagnostic or non-diagnostic information.

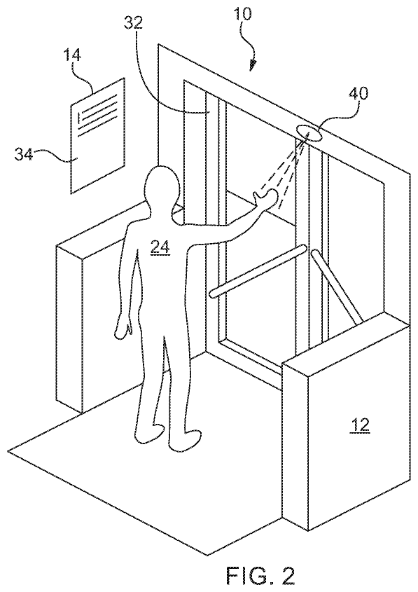

The transit vehicle 12 may be a bus, railway passenger vehicle, or any other suitable vehicle. The display 14 may be manufactured with at least one of the following technologies: thin-film transistor (TFT) liquid-crystal, organic light-emitting diode (OLED), electronic ink (eINK), liquid-crystal (LCD), light-emitting diode (LED), although other suitable display technologies may also be utilized. The display 14 may be mounted on or in a door 32 of the vehicle 12 (FIG. 1), on or in a window or modesty panel 34 (FIG. 2), mounted to a vehicle structure 36, such as a ceiling, and/or provided on a dashboard 38 of the transit vehicle.

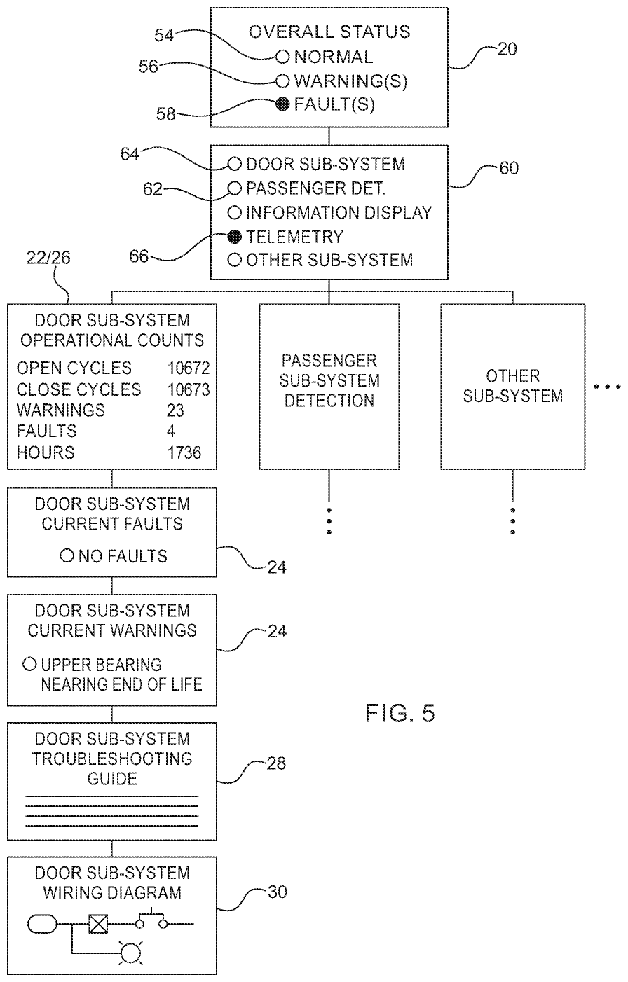

Referring to FIG. 5, the diagnostic information includes the system status 20, operational counts and operating times 22, current faults and warnings 24, historical faults and warnings 26, the troubleshooting guide 28, and the component documentation 30, although other suitable diagnostic information and combinations may be utilized. The diagnostic information may be stored locally, uploaded locally, uploaded remotely, and/or provided and changed real-time via a network connection.

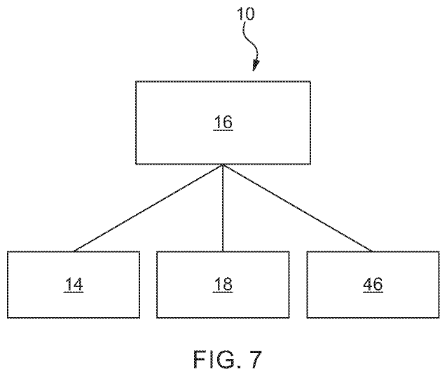

Referring to FIGS. 2 and 7, according to one aspect, the display actuation sub-system 18 includes a sensor 40 configured to detect a person on the transit vehicle. The sensor 40 may include one or more of the following: a passive infrared (PIR) sensor, a microwave sensor, an ultrasonic sensor, a vibration sensor, a pressure/contact sensor, a camera-based sensor, or any other suitable sensor and combinations of sensor technologies configured to detect the position of one or more vehicle passengers. The display actuation sub-system 18 may also be a camera-based facial expression recognition system or gesture recognition system.

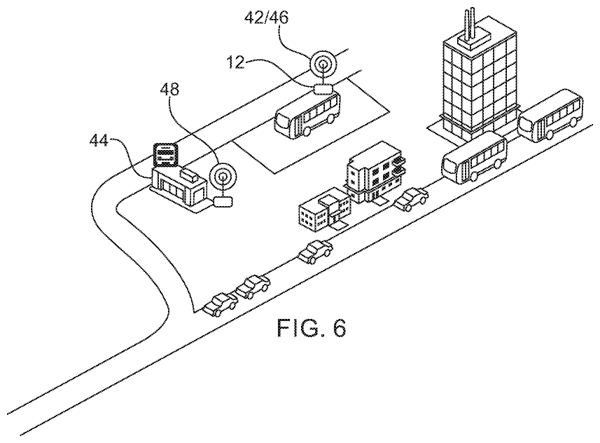

Referring to FIGS. 6 and 7, according to one aspect, the display actuation sub-system 18 is a location-based sensor 42 configured to send the display signal to the control module 16 based on a location of the transit vehicle 12. The location-based sensor 42 is configured to send the display signal to the control module 16 based on a location of the transit vehicle 12 relative to a geo-fence. For example, when the transit vehicle 12 reaches a predetermined distance from a repair facility 44, the display 14 may automatically display the diagnostic information on the display 14 to assist repair personnel in addressing any maintenance issues with the transit vehicle 12. In a further aspect, the display actuation sub-system 18 includes a first communication module 46 on the transit vehicle 12 and a second communication module 48 at the repair facility 44, with the second communication module 48 communicating with the first communication module 46 to send the display signal to the control module 16. The first and second communication modules 46, 48 may include a cellular mobile communication device, a wireless local area networking device, and/or any other suitable communication device for receiving and transmitting information.

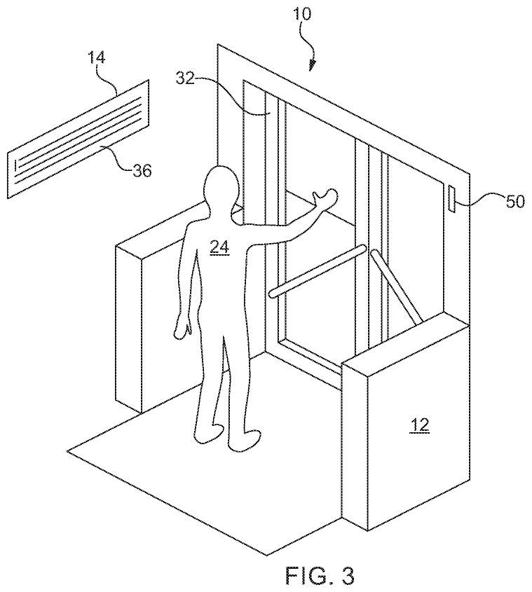

Referring to FIGS. 3 and 7, according to one aspect, the display actuation sub-system 18 includes an input panel 50 configured to be actuated by a user to send the display signal to the control module 16. The input panel 50 may be a button, a touch screen, an external keypad, a trackpad, or any other suitable device or arrangement.

Referring to FIGS. 1 and 7, according to one aspect, the display actuation sub-system 18 includes a smart phone 52 configured to send the display signal to the control module 16 based on a user input on the smart phone 52 or a location of the smart phone 52 relative to the display 14. The smart phone 52 may include an application to allow control of the display 14 to display the desired diagnostic information or may trigger the display of the diagnostic information on the display 14 when the smart phone 52 is within a predetermined distance from the display 14 or control module 16.

Referring to FIG. 5, according to one aspect, the system status 20 of the diagnostic information comprises a normal indicator 54, a warning indicator 56, and a fault indicator 58. The system status of the diagnostic information includes a sub-system status 60 for each sub-system, with the sub-system status also including a normal indicator 62, a warning indicator 64, and a fault indicator 66. In one aspect, the normal indicator 62 for the sub-system status 60 is a first color, the warning indicator 64 for the sub-system status 60 is a second color, and the fault indicator 66 for the sub-system status 60 is a third color, with the first color, the second color, and the third color each a different color relative to each other. The normal indicator 62 may be a green light, the warning indicator 64 may be a yellow light, and the fault indicator 66 may be a red light, although other suitable colors and indicators may be utilized.

While embodiments of a door assembly were provided in the foregoing description, those skilled in the art may make modifications and alterations to these embodiments without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are to be embraced within their scope.

The invention claimed is:

1. A diagnostic system for a transit vehicle comprising:
(a) a display configured to display diagnostic information; and
(b) a control module comprising at least one processor programmed or configured to:
(i) receive a display signal from a display actuation sub-system; and
(ii) display the diagnostic information on the display, wherein the diagnostic information comprises one or more of a system status, operational counts and operating times, current faults and warnings, historical faults and warnings, a troubleshooting guide, and component documentation.

2. The diagnostic system of claim 1, wherein the diagnostic information comprises a system status, operational counts and operating times, current faults and warnings, and historical faults and warnings.

3. The diagnostic system of claim 2, wherein the diagnostic information further comprises a troubleshooting guide and component documentation.

4. The diagnostic system of claim 1, wherein the display actuation sub-system comprises a sensor configured to detect a person on the transit vehicle.

5. The diagnostic system of claim 4, wherein the sensor comprises a passive infrared (PIR) sensor, a microwave sensor, an ultrasonic sensor, a vibration sensor, a pressure/contact sensor, and/or a camera-based sensor.

6. The diagnostic system of claim 1, wherein the display actuation sub-system comprises a camera-based facial expression recognition system or gesture recognition system.

7. The diagnostic system of claim 1, wherein the display actuation sub-system comprises a location-based sensor configured to send the display signal to the control module based on a location of the transit vehicle.

8. The diagnostic system of claim 7, wherein the location-based sensor is configured to send the display signal to the control module based on a location of the transit vehicle relative to a geo-fence.

9. The diagnostic system of claim 1, wherein the display actuation sub-system comprises a first communication module on the transit vehicle and a second communication module at a repair facility, the second communication module communicating with the first communication module to send the display signal to the control module.

10. The diagnostic system of claim 1, wherein the display actuation sub-system comprises an input panel configured to be actuated by a user to send the display signal to the control module.

11. The diagnostic system of claim 1, wherein the display actuation sub-system comprises a smart phone configured to send the display signal to the control module based on a user input on the smart phone or a location of the smart phone relative to the display.

12. The diagnostic system of claim 1, wherein the system status of the diagnostic information comprises a normal indicator, a warning indicator, and a fault indicator.

13. The diagnostic system of claim 12, wherein the system status of the diagnostic information further comprises a sub-system status for each sub-system, the sub-system status comprises a normal indicator, a warning indicator, and a fault indicator.

14. The diagnostic system of claim 13, wherein the normal indicator for the sub-system status comprises a first color, the warning indicator for the sub-system status comprises a second color, and the fault indicator for the sub-system status comprises a third color, and wherein the first color, the second color, and the third color are each a different color relative to each other.

15. A computer-implemented method for displaying diagnostic information on a display for a transit vehicle, the method comprising:
determining with at least one processor whether a display signal was received from a display actuation sub-system; and
displaying the diagnostic information on a display, wherein the diagnostic information comprises one or more of a system status, operational counts and operating times, current faults and warnings, historical faults and warnings, a troubleshooting guide, and component documentation.

16. The method of claim 15, wherein the display actuation sub-system comprises a sensor, the method further comprising detecting a presence of a person on the transit vehicle and generating the display signal.

17. The method of claim 15, wherein the display actuation sub-system comprises a location-based sensor, the method further comprising detecting a location of the transit vehicle and generating the display signal based on the location of the transit vehicle.

18. The method of claim 17, further comprising detecting the location of the transit vehicle relative to a geo-fence.

19. The method of claim 15, wherein the display actuation sub-system comprises a first communication module on the transit vehicle and a second communication module at a repair facility, the method further comprising enabling communication between the second communication module and the second communication module to send the display signal.

20. The method of claim 15, wherein the display actuation sub-system comprises a smart phone, the method further comprising detecting a location of the smart phone and generating the display signal based on the location of the smart phone.
